(19) United States
(12) Patent Application Publication
(10) Pub. No.: US 2017/0093586 A1
(43) Pub. Date: Mar. 30, 2017

(54) TECHNIQUES FOR MANAGING CERTIFICATES ON A COMPUTING DEVICE

(71) Applicant: QUALCOMM Incorporated, San Diego, CA (US)

(72) Inventors: Maria MIRANDA, San Diego, CA (US); Qazi BASHIR, San Diego, CA (US); Satyajit PATNE, San Diego, CA (US); Ron KEIDAR, San Diego, CA (US)

(21) Appl. No.: 14/865,448

(22) Filed: Sep. 25, 2015

(51) Int. Cl. H04L 9/32

(52) U.S. Cl. CPC H04L 9/3268

(57) ABSTRACT

Techniques for managing certificates on a computing device are provided. An example method according to these techniques includes receiving an image file comprising a hash value of a certificate on which a certificate action is to be performed, the certificate action being a revocation action or an activation action, the image file having been signed by a signing certificate, determining whether the image file has been signed by a valid certificate by comparing a hash value of the signing certificate to a plurality of hash values associated with certificates stored in a one-time programmable memory of the computing device, and performing the certificate action, responsive to the image file having been signed by the valid certificate and the certificate on which the certificate action is to be performed having been found in the memory, by setting a value of an indicator associated with the certificate in the memory.

### BACKGROUND

Computing devices, such as laptops, mobile phones, smartphones, smartwatches, and other types of computing devices, can use certificates cryptographic certificates as part of a public key infrastructure. The certificates can be used in various ways by the computing device. For example, the certificates can be used to sign image files to be deployed on the computing device to ensure that software, such as operating system files and/or other software to be executed by the computing device has been provided by a trusted source.

A certificate may be irreversibly revoked in certain situations, such as the Certificate Authority (CA) had improperly issued the certificate, or the private-key is compromised. A certificate may also be revoked if the entity identified by the certificate fails to adhere to policy requirements, such as publication of false documents, misrepresentation of software behavior, or violation of any other policy specified by the CA operator or the CA's customer. The most common reason for revocation is the user no longer being in sole possession of the private key (e.g., the token containing the private key has been lost or stolen). The most common implementation of revocation uses Certification Revocation Lists (CRLs). A CRL enumerates a list of digital certificates as well as the reason for revocation of each of the certificates. CRLs do not provide a good solution for mobile computing systems and/or embedded computing system environments, because the CRL must be updated frequently and can consume a significant amount of space in the often limited memory of such computing devices.

### SUMMARY

An example method for managing certificates on a computing device includes receiving, at the computing device, an image file comprising a hash value of a certificate on which a certificate action is to be performed, the certificate action being a revocation action or an activation action, the image file having been signed by a signing certificate, determining whether the image file has been signed by a valid certificate by comparing a hash value of the signing certificate to a plurality of hash values associated with certificates stored in a one-time programmable memory of the computing device, and performing the certificate action on the certificate on which the certificate action is to be performed, responsive to the image file having been signed by the valid certificate and the certificate on which the certificate action is to be performed having been found in the one-time programmable memory of the computing device, by setting a value of an indicator associated with the certificate in the one-time programmable memory.

Implementations of such a method can include one or more of the following features. The signing certificate and the certificate are a same certificate. Determining whether the image file has been signed by the certificate by comparing the hash value of the signing certificate to the plurality of hash values associated with certificates stored in the one-time programmable memory of the computing device includes identifying a hash value of the plurality of hash values associated with certificates stored in the one-time programmable memory of the computing device that matches the hash value of the signing certificate, and determining whether a certificate associated with the hash value identified is active. Determining whether the certificate associated with the hash value identified is active includes determining a hash of the hash value of the hash value identified, and determining whether a second indicator in the one-time programmable memory of the computing device associated with the hash value of the hash value identified is set to a value indicative that the certificate is active. Determining whether a first indicator in the one-time programmable memory of the computing device associated with the hash value of the hash value identified is set to a value indicative that the certificate has not been revoked. The certificate action is the revocation action, and performing the certificate action on the certificate includes identifying a hash value of the plurality of hash values associated with certificates stored in the one-time programmable memory of the computing device that matches the hash value of the certificate, determining a hash value of the hash value of the hash value identified, and setting a value of a first indicator in the one-time programmable memory of the computing device associated with the hash value of the hash value of the hash value identified to irrevocably revoke the certificate. Determining whether any other root certificates associated with the plurality of hash values associated with certificates stored in the one-time programmable memory are active and have not been revoked prior to setting the value of the first indicator in the one-time programmable memory. The certificate action is the activation action, and performing the certificate action on the certificate includes identifying a hash value of the plurality of hash values associated with certificates stored in the one-time programmable memory of the computing device that matches the hash value of the certificate, determining a hash value of the hash value of the certificate, and setting the value of a second indicator in the one-time programmable memory of the computing device associated with the hash value of the hash value of the certificate to activate the certificate. Determining whether the certificate has been revoked by determining whether a first indicator in the one-time programmable memory of the computing device associated with the hash value of the hash value of the certificate is set to a value indicative that the certificate has not been revoked. An indicator in the one-time programmable memory can comprise a fuse, an antifuse, or other type of indicator that can represent one or more bits of data. The value of an indicator can be set by blowing a fuse or otherwise irrevocably setting a value in the one-time programmable memory.

An example apparatus according to the disclosure includes means for receiving an image file comprising a hash value of a certificate on which a certificate action is to be performed, the certificate action being a revocation action or an activation action, the image file having been signed by a signing certificate, means for determining whether the image file has been signed by a valid certificate by comparing a hash value of the signing certificate to a plurality of hash values associated with certificates stored in a one-time programmable memory of the apparatus, and means for performing the certificate action on the certificate responsive to the image file having been signed by the valid certificate and the certificate on which the certificate action is to be performed having been found in the one-time programmable memory of the apparatus by setting a value of an indicator associated with the certificate in the one-time programmable memory.

Implementations of such an apparatus can include one or more of the following features. The signing certificate and the certificate are a same certificate. The means for determining whether the image file has been signed by the valid certificate by comparing the hash value of the signing certificate to the plurality of hash values associated with certificates stored in the one-time programmable memory of the apparatus include means for identifying a hash value of the plurality of hash values associated with certificates stored in the one-time programmable memory of the apparatus that matches the hash value of the signing certificate, and means for determining whether a certificate associated with the hash value identified is active. The means for determining whether the certificate associated with the hash value identified is active include means for determining a hash of the hash value of the hash value identified, and means for determining whether a second indicator in the one-time programmable memory of the apparatus associated with the hash value of the hash value identified is set to a value indicative that the certificate is active. Means for determining whether a first indicator in the one-time programmable memory of the apparatus associated with the hash value of the hash value identified is set to a value indicative that the certificate has not been revoked. The certificate action is the revocation action, and the means for performing the certificate action on the certificate include means for identifying a hash value of the plurality of hash values associated with certificates stored in the one-time programmable memory of the apparatus that matches the hash value of the certificate, means for determining a hash value of the hash value of the certificate, and means for setting the value of a first indicator in the one-time programmable memory of the apparatus associated with the hash value of the hash value of the certificate to irrevocably revoke the certificate. Means for determining whether any other root certificates associated with the plurality of hash values associated with certificates stored in the one-time programmable memory are active and have not been revoked prior to setting a value of the first indicator in the one-time programmable memory. The certificate action is the activation action, and the means for performing the certificate action on the certificate include means for identifying a hash value of the plurality of hash values associated with certificates stored in the one-time programmable memory of the apparatus that matches the hash value of the certificate, means for determining a hash value of the hash value of the certificate, and means for setting the value of a second indicator in the one-time programmable memory of the apparatus associated with the hash value of the hash value of the certificate to activate the certificate. Means for determining whether the certificate has been revoked, the means for determining whether the certificate has been revoked include means for determining whether a first indicator in the one-time programmable memory of the apparatus associated with the hash value of the hash value of the certificate is set to a value indicative that the certificate has not been revoked. An indicator in the one-time programmable memory can comprise a fuse, an antifuse, or other type of indicator that can represent one or more bits of data. The value of an indicator can be set by blowing a fuse or otherwise irrevocably setting a value in the one-time programmable memory.

An example computing device according to the disclosure includes a one-time programmable memory and at least one processor coupled to the one-time programmable memory. The at least one processor is configured to receive an image file comprising a hash value of a certificate on which a certificate action is to be performed, the certificate action being a revocation action or an activation action, the image file having been signed by a signing certificate, determine whether the image file has been signed by a valid certificate by comparing a hash value of the signing certificate to a plurality of hash values associated with certificates stored in the one-time programmable memory, and perform the certificate action on the certificate responsive to the image file having been signed by the valid certificate and the certificate on which the certificate action is to be performed having been found in the one-time programmable memory by setting a value of an indicator associated with the certificate in the one-time programmable memory.

Implementations of such a computing device can include one or more of the following features. The signing certificate and the certificate are a same certificate. The certificate action is the revocation action, and the at least one processor being configured to perform the certificate action on the certificate is further configured to identify a hash value of the plurality of hash values associated with certificates stored in the one-time programmable memory that matches the hash value of the certificate, determine a hash value of the hash value of the certificate, and set the value of a first indicator in the one-time programmable memory associated with the hash value of the hash value of the certificate to irrevocably revoke the certificate. The at least one processor is further configured to determine whether any other root certificates associated with the plurality of hash values associated with certificates stored in the one-time programmable memory are active and have not been revoked prior to setting the value of the first indicator in the one-time programmable memory. The certificate action is the activation action, and the at least one processor being configured to perform the certificate action on the certificate is further configured to identify a hash value of the plurality of hash values associated with certificates stored in the one-time programmable memory that matches the hash value of the certificate, determine a hash value of the hash value of the certificate, and set the value of a second indicator in the one-time programmable memory associated with the hash value of the hash value of the certificate to activate the certificate. The at least one processor is further configured to determine whether the certificate has been revoked, the at least one processor being configured to determine whether the value of a first indicator in the one-time programmable memory associated with the hash value of the hash value of the certificate is set to a value indicative that the certificate has not been revoked. An indicator in the one-time programmable memory can comprise a fuse, an antifuse, or other type of indicator that can represent one or more bits of data. The value of an indicator can be set by blowing a fuse or otherwise irrevocably setting a value in the one-time programmable memory.

An example non-transitory, computer-readable medium according to the disclosure has stored thereon computer-readable instructions for managing certificates on a computing device. The instructions stored thereon include instructions configured to cause the computing device to receive an image file comprising a hash value of a certificate on which a certificate action is to be performed, the certificate action being a revocation action or an activation action, the image file having been signed by a signing certificate, determine whether the image file has been signed by a valid certificate by comparing a hash value of the signing certificate to a plurality of hash values associated with certificates stored in a one-time programmable memory of the computing device, and perform the certificate action on the certificate responsive to the image file having been signed by the valid certificate and the certificate on which the certificate action is to be performed having been found in the one-time programmable memory of the computing device by setting a value of an indicator associated with the certificate in the one-time programmable memory.

Implementations of such a non-transitory, computer-readable medium can include one or more of the following features. The signing certificate and the certificate are a same certificate. The instructions configured to cause the computing device to determine whether the image file has been signed by the valid certificate by comparing the hash value of the signing certificate to the plurality of hash values associated with certificates stored in the one-time programmable memory of the computing device include instructions configured to cause the computing device to identify a hash value of the plurality of hash values associated with certificates stored in the one-time programmable memory of the computing device that matches the hash value of the signing certificate, and determine whether a certificate associated with the hash value identified is active. The certificate action is the revocation action, and the instructions configured to cause the computing device to perform the certificate action on the certificate include instructions configured to cause the computing device to identify a hash value of the plurality of hash values associated with certificates stored in the one-time programmable memory of the computing device that matches the hash value of the certificate, determine a hash value of the hash value of the certificate, and set the value of a first indicator in the one-time programmable memory of the computing device associated with the hash value of the hash value of the certificate to irrevocably revoke the certificate. The certificate action is the activation action, and the instructions configured to cause the computing device to perform the certificate action on the certificate include instructions configured to cause the computing device to identify a hash value of the plurality of hash values associated with certificates stored in the one-time programmable memory of the computing device that matches the hash value of the certificate, determine a hash value of the hash value of the certificate, and set the value of a second indicator in the one-time programmable memory of the computing device associated with the hash value of the hash value of the certificate to activate the certificate. Instructions configured to cause the computing device to determine whether the certificate has been revoked, the instructions including instructions configured to determine whether a first indicator in the one-time programmable memory of the computing device associated with the hash value of the hash value of the certificate is set to a value indicative that the certificate has not been revoked. An indicator in the one-time programmable memory can comprise a fuse, an antifuse, or other type of indicator that can represent one or more bits of data. The value of an indicator can be set by blowing a fuse or otherwise irrevocably setting a value in the one-time programmable memory.

### BRIEF DESCRIPTION OF THE DRAWINGS

FIG. 1 is a block diagram of an example network architecture, which may be suitable for implementing the techniques discussed herein.

FIG. 2 is a block diagram of an example computing device that can be used to implement the computing device illustrated in FIG. 1.

FIG. 3 is a functional block diagram of the computing device illustrated in FIG. 2 that illustrates functional units of the computing device.

FIG. 4 is a block diagram illustrating aspects of the provisioning process according to the techniques discussed herein.

FIG. 5 is a flow diagram of an example process for provisioning according to the techniques discussed herein.

FIG. 6 is a flow diagram of an example process for managing certificates on a computing device according to the techniques discussed herein.

FIG. 7 is a flow diagram of an example process for determining whether a certificate is active on a computing device according to the techniques discussed herein.

FIG. 8 is a flow diagram of an example process for determining whether a certificate is active on a computing device according to the techniques discussed herein.

FIG. 9 is a flow diagram of an example process for revoking a certificate on a computing device according to the techniques discussed herein.

FIG. 10 is a flow diagram of an example process for revoking a certificate on a computing device according to the techniques discussed herein.

FIG. 11 is a flow diagram of an example process for activating a certificate on a computing device according to the techniques discussed herein.

FIG. 12 is a flow diagram of an example process for activating a certificate on a computing device according to the techniques discussed herein.

FIG. 13 is a flow diagram of an example process for generating an image file that can be used to provision certificates on a computing device or to manage the certificates already on the device according to the techniques discussed herein.

FIG. 14 is a flow diagram of an example process for provisioning according to the techniques discussed herein.

### DETAILED DESCRIPTION

Techniques are disclosed herein for managing certificates on a computing device. The certificates can include root certificates and/or attestation certificates. A root certificate can be associated with one or more attestation certificates and/or one or more versions of the attestation certificates. The techniques discussed herein can be used to perform a certificate action on one or more of these certificates to activate one or more certificates, revoke one or more certificates, and/or perform other actions one or more certificates. The certificate actions specified in image files that are provided to the computing device. The following examples illustrate these techniques.

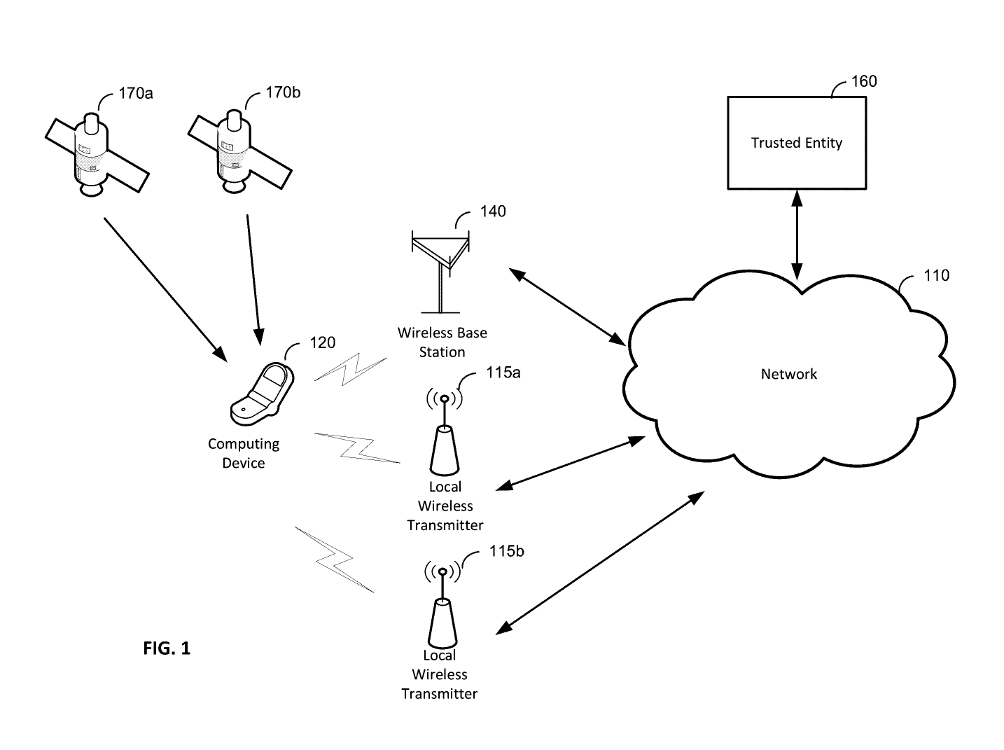

FIG. 1 is a block diagram of an example network architecture, which may be suitable for implementing the techniques discussed herein. The particular configuration illustrated herein is merely an example of one network configuration in which the techniques disclosed herein may be used. Furthermore, an implementation of such a network architecture may include additional elements that are not illustrated herein and have been omitted for the sake of clarity. The example network architecture provides an example of a network environment in which a computing device in which the techniques disclosed herein may be implemented can operate.

The computing device 120 can be a mobile device as illustrated in the example in FIG. 1 or may be a device that is typically stationary, such as a desktop computer system. The computing device 120 can be a mobile communication device referred to as a User Equipment (UE), a mobile station, a terminal, an access terminal, a subscriber unit, a station, etc. The computing device 120 can be a smartphone, a tablet computer, a laptop computer, game console, wearable device (such as a smart watch) or other device that includes a wireless transmitter that is configured to communicate using one or more wireless communications protocols, including, but not limited to, the Long Term Evolution (LTE), WLAN, and WiMAX wireless communications protocols. The computing device 120 can also be configured to support other types of wireless or wired communications protocols and can be configured to support multiple different wireless communications protocols. The wireless transmitter of the computing device 120 can be configured to send data to and/or receive data from other devices, the wireless transmitters 115, and/or one or more wireless base stations 140.

The computing device 120 can also be configured to measure signals from one or more wireless base stations or wireless access points, such as the wireless transmitters 115 and the wireless base station 140, and obtain timing measurements (e.g., for time of arrival (TOA) or observed time difference of arrival (OTDOA)), signal strength measurements (e.g., Receive Signal Strength Indication (RSSI)), RTT (round-trip time) and/or signal quality measurements for the wireless base stations. The pseudo-range measurements, timing measurements, signal strength measurements, and/or signal quality measurements may be used to derive a location estimate for the computing device 120. A location estimate may also be referred to as a position estimate, a position fix, etc. Two local terrestrial wireless transmitters are illustrated in this example: 115a and 115b. However, in other implementations, more or less wireless transmitters 115 may be included. The computing device 120 can also be configured to use a combination of signals from one or more of the satellites 170, the wireless base station 140, and/or the wireless transmitters 115 to determine a position of the computing device 120.

Each of the wireless transmitters 115 can comprise a WLAN wireless access point configured to operate using the IEEE 802.11 wireless communication standards. But, in some implementations some or all of the wireless transmitters 115 may be configured to utilize other wireless communications protocols, and some network environments may include more than one type of wireless transmitter. Furthermore, while the wireless transmitters 115 are identified as transmitters, the wireless transmitters 115 may be transceivers configured to send and/or receive data wirelessly. The wireless transmitters 115 can be connected to network 110 via a backhaul connection that provides a broadband connection to the network 110. The network 110 may be the Internet and/or a combination of one or more networks. For example, the wireless transmitter (such as one of the wireless transmitters 115) may be connected to a DSL modem or a cable modem, depending upon the type of broadband service being used in that particular implementation. A wireless transmitter (such as one of the wireless transmitters 115) can be associated with a mobile communication network provider and can be configured to communicate with the mobile communication network provider's network (not shown) via the network 110. The coverage area of the a wireless transmitter (such as one of the wireless transmitters 115) may overlap with that of one or more macrocell base stations, such as wireless base station 140, or that of one or more other terrestrial transceivers.

The wireless base station 140 can be configured to provide wireless network connectivity to a plurality of mobile devices, such as computing device 120. The wireless base station 140 can comprise a macrocell base station, a femtocell base station, a picocell base station, or other type of base station. The wireless base station 140 may have a much larger coverage area than the wireless transmitter (such as one of the wireless transmitters 115) or may be a terrestrial transceiver that provides a coverage area that is of a similar size or of a smaller size than the coverage area provided by the wireless transmitters 115. Wireless base station 140 can be configured to communicate using one or more wireless communications protocols. While the example illustrated in FIG. 1 includes on a single wireless base station, in other implementations the network environment is likely to include more than wireless base station 140 which have coverage areas that may overlap at least in part.

The computing device 120 can be configured to include a Global Navigation Satellite System (GNSS) receiver configured to receive and measure signals from one or more satellites 170, such as satellite 170a and satellite 170b, and to obtain pseudo-range measurements for the satellites 170. Satellites 170 may be part of a Global Navigation Satellite System (GNSS), which may be the United States Global Positioning System (GPS), the European Galileo system, the Russian GLONASS system, or some other GNSS. The GNSS receiver may also be configured to detect and receive signals from satellites 170 belonging to more than one GNSS system. For example, satellite 170a could belong to the GPS system while the satellite 170b could belong to the Galileo system. While the example network architecture illustrated herein illustrates only two satellites, other implementations may have more or less satellites available, may have satellites associated with one or more GNSS system, and the number of satellites visible to the computing device 120 may depend upon the current geographical location of the computing device 120 and the orbits of the satellites 170. Typically, the computing device 120 will attempt to acquire signals from at least four SVs in order to perform trilateration to determine the location of the computing device 120.

The trusted entity 160 can be configured to provide downloadable content to the computing device 120, such as software and/or operating system updates. The trusted entity 160 can also be configured to attest to the authenticity of a signed software image based on the certificate used to sign the software image. The trusted entity 160 is illustrated as a single entity in the example illustrated in FIG. 1. However, the logical functions attributed to the trusted entity 160 discussed herein may be distributed across multiple trusted entities operated by various third parties. Furthermore, the functionality of the trusted entity 160 can be distributed across multiple network connected servers.

The example network configuration illustrated in FIG. 1 is merely an example of one possible configuration of a network in which the techniques disclosed herein may be implemented. Other network configurations may include additional elements not illustrated in FIG. 1 and the various components may be interconnected in a different configuration than what is shown in FIG. 1. Furthermore, as discussed above, the computing device 120 can be implemented such that the computing device 120 includes a wired connection to the network 110 instead of or in addition to the wireless connections illustrated in FIG. 1. Furthermore, the computing device 120 can be configured to remain in a relatively fixed location, such as a set-top box, a server computer system, or desktop computer system that may be moved but typically remains in the same location in contrast to the implementation of the computing device 120 as a mobile device as illustrated in FIG. 1.

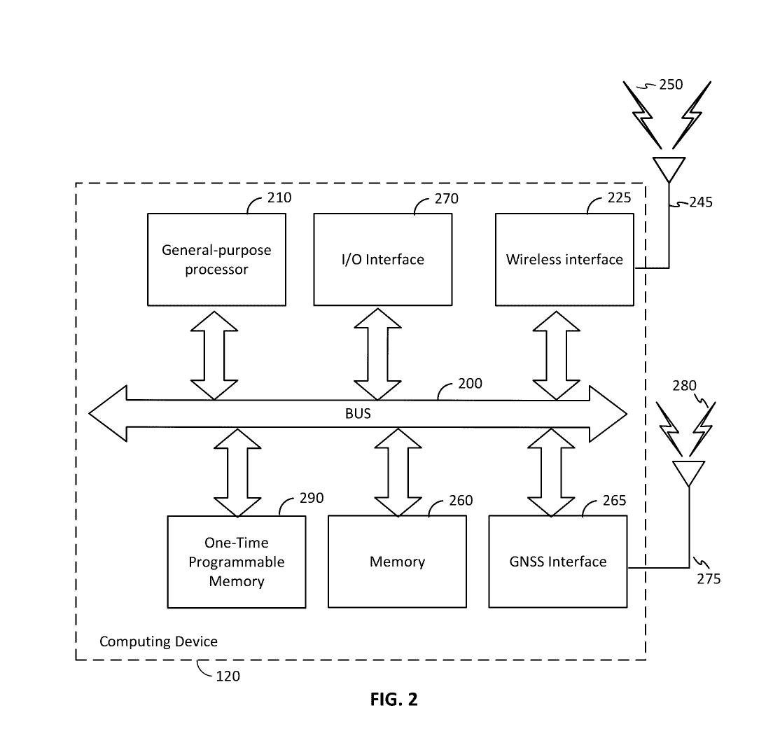

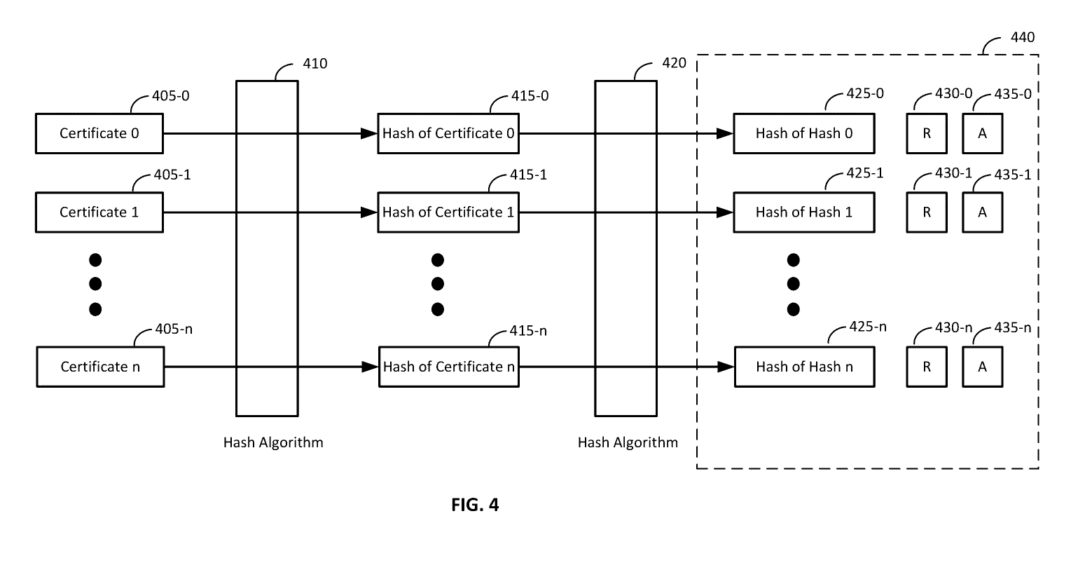

FIG. 2 is a block diagram of a computing device that can be used to implement the computing device 120 illustrated in FIG. 1. The computing device 120 can be used to implement, at least in part, the processes illustrated in FIG. 4-14. The computing device 120 can be various types of computing devices, including but not limited to, laptop or other personal computer systems, tablet computers, mobile phones, smartphones, game consoles, wearable devices (e.g., a smartwatch, head-mounted device, etc.) and/or other types of computing devices.

The computing device 120 comprises computer system including at least one processor 210, a wireless interface 225, a GNSS interface 265, and a non-transitory memory 260, connected to each other by a bus 200. The at least one processor 210 can include a general-purpose processor. Other implementations of the computing device 120 may include additional elements not illustrated in the example implementation of FIG. 2 and/or may not include all of the elements illustrated in the example embodiment illustrated in FIG. 2. Some implementations of the computing device 120 may not include the GNSS interface 265 and/or the wireless interface 225. The computing device 120 can include a wired network interface instead of or in addition to the wireless interface 225. The computing device 120 may be implemented as a set-top box, desktop computing device, or other device that may be moved but typically not intended to be as portable as a mobile phone, laptop computer, tablet computer, a wearable device, or other such computing device that may be referred to as a mobile device.

The wireless interface 225 can include a wireless receiver, transmitter, transceiver, and/or other elements that enable the computing device 120 to send and/or receive data using WWAN, WLAN, and/or other wireless communication protocols. The wireless interface 225 can comprise one or more multi-mode modems capable of transmitting and receiving wireless signals using multiple wireless communications standards. The wireless interface 225 is connected an antenna 245 for sending and receiving communications to/from the wireless transmitters 115 as wireless signals 250, the wireless base station 140, and/or other wireless devices configured to communicate using wireless communication protocols. While the computing device 120 illustrated in FIG. 2 comprises a single wireless interface and a single antenna, other implementations of the computing device 120 can include multiple wireless interfaces and/or multiple antennas.

I/O interface 270 can provide one or more ports and/or other interfaces that can provide for data inputs and/or outputs to the computing device 120. For example, the I/O interface 270 can include one or more ports, such as a Universal Serial Bus (USB) port and/or other type of port that can be used to connect external devices to the computing device 120. The I/O interface 270 can also include one or more input devices, such as buttons, switches, a keypad, a touchscreen and/or other means for receiving input from a user. The I/O interface 270 can also include one or more means for outputting audio and/or visual content, such as a screen, a speaker, a headphone port and/or other means for outputting such content.

The GNSS interface 265 can include a GNSS receiver and/or other elements that enable the computing device 120 to receive signals from transmitters associated with one or more GNSS systems. The GNSS interface 265 is connected to an antenna 275 for receiving signals 280 from the GNSS transmitters, such as the satellites 170 illustrated in FIG. 1. The computing device 120 can be configured to use signals received from satellites associated with satellites and other transmitters associated with the GNSS systems to determine a position of the computing device 120. The computing device 120 can also be configured to use the signals received from the satellites and other transmitters associated with the GNSS systems in conjunction with signals received from wireless transmitters 115 and/or wireless base stations (such as wireless base station 140) to determine a position of the computing device 120.

The processor 210 can be an intelligent device, e.g., a personal computer central processing unit (CPU), a microcontroller, an application specific integrated circuit (ASIC), etc. The memory 260 is a non-transitory storage device that can include random access memory (RAM), read-only memory (ROM), or a combination thereof. The memory 260 can store processor-readable, processor-executable software code containing instructions for controlling the processor 210 to perform functions described herein (although the description may read that the software performs the function(s)). The software can be loaded onto the memory 260 by being downloaded via a network connection, uploaded from a disk, etc. Further, the software may not be directly executable, e.g., requiring compiling before execution.

The software in the memory 260 is configured to enable the processor 210 to perform various actions, including implementing sending and/or receiving data from the wireless transmitters 115, the wireless base station 140, other mobile devices, and/or other devices configured for wireless communication. The software in the memory 260 can also configured to enable the processor 210 to perform all or part of one or more of the processes illustrated in FIGS. 4-14. The processes illustrated in FIGS. 4-14 can also be implemented in hardware components of the computing device 120 or can be implemented as a combination of hardware and software components.

The memory 290 is one-time programmable memory non-volatile memory. The memory 290 can comprise one or more indicators that can be used to represent a bit of data. The values of the bit can be set permanently and irreversibly to a value. In some implementations, the value of the bit can be permanently set by blowing a fuse in the memory associated with a particular bit. The example implementations of FIGS. 4-14 discuss blowing a fuse to permanently set a bit in order to permanently revoke or to activate a certificate stored in the memory 290. However, not all one-time programmable memory non-volatile memory comprises fuses, and other techniques can be used to set an indicator in the memory. The memory 290 can be used to store root certificates, attestation certificates, or other types of certificates that can be utilized by the computing device 120, and the techniques discussed in FIGS. 4-14 can be used for provisioning and/or maintaining the certificates for the computing device 120.

In the techniques discussed herein and illustrated in FIGS. 4-14, the certificates provisioned to the computing device 120 are not stored in the memory 290. Instead, a hash of each of the certificates can be stored in the memory 290. This approach can be used to conserve space in the one-time programmable memory 290 of the computing device 120. The one-time programmable memory can be expensive compared to read-write memory components, which can be included in the computing device 120. Hashing each of the certificates can significantly reduce the size of the chain of certificates that is stored on the computing device 120. The memory 290 can also include a hash table that maps each of the hash values of the certificates to a set of one or more fuses in the memory 290. For example, a hash of a certificate can have a first fuse or other indicator in memory that indicates whether the certificate has been revoked and can have a second fuse that indicates which the certificate has been activated. Activation and revocation of certificates can be achieved by blowing the appropriate fuse or setting the appropriate indicator in memory. Revocation is irrevocable. Once the fuse is blown or the value of the other indicator in memory is set the value cannot be changed. Furthermore, any other certificates signed by the certificate being revoked will also be revoked.

The memory 290 can alternatively be implemented using a form of one-time programmable memory 290 that utilizes antifuses instead of fuses or other types of indicators that can be used to represent a value that, once set, is irrevocably set. While the example processes discussed herein discuss blowing a fuse to set a bit value or reading a fuse to determine a bit value, these processes can also be implemented using memory comprising antifuses and/or other types of indicators and the activation and/or revocation of the certificate can be achieved by permanently setting the appropriate antifuse or other indicator in memory.

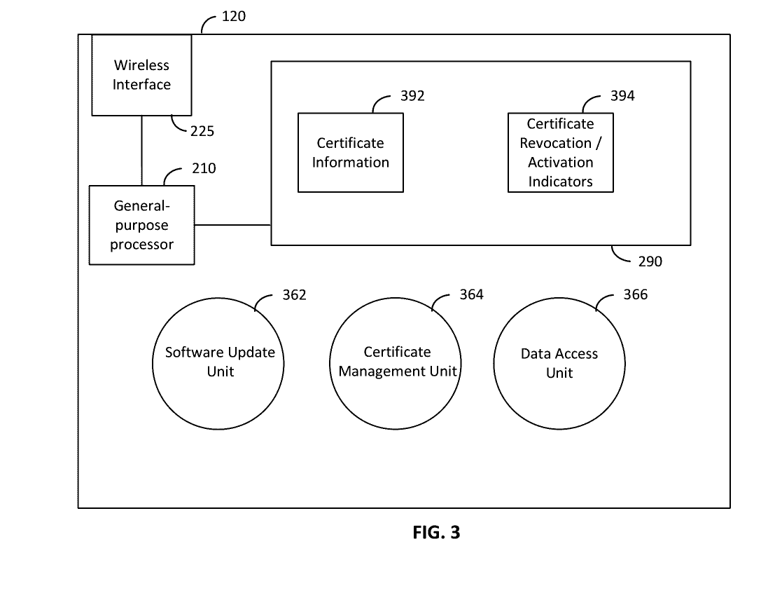

FIG. 3 is a functional block diagram of the computing device 120 illustrated in FIG. 2 that illustrates functional units of the computing device 120 and contents of memory 290. The computing device 120 can include a software update unit 362, a certificate management unit 364, and a data access unit 366. The functional units 362, 364, and 366 can be implemented as software modules stored in the memory 260 which are executable by the processor 210. The functional units can be implemented as digital and/or analog hardware components of the computing device 120 and can be either implemented as components of the processor 210 and/or separate hardware components. The functional units can also be implemented as a combination of hardware and software components. The computing device 120 illustrated in FIGS. 2 and 3 can be used to implement the computing device 120 associated with the processes illustrated in FIGS. 4-14. The processor 210 and the functional units 362, 364, and 366 can provide means for implementing the various stages of the processes illustrated in FIGS. 4-14 unless otherwise specified.

The software update unit 362 can be configured to receive image files containing software updates, configuration file updates, and/or certificate action information regarding revocations and/or activation information for one or more certificates stored in the memory 290 of the computing device 120. The software update unit 362 can be configured to receive the image files from a network entity, such as the trusted entity 160 via a wired or wireless network connection. The image files can be transmitted over the network 110 and/or one or more intervening networks, such as a wireless communication network associated with the wireless transmitters 115 and/or the wireless base station 140. The trusted entity 160 or another network entity can push the image files that include updates and/or certificate action information to the computing device 120. The software update unit 362 can also be configured to request software updates from the trusted entity 160 or other network entity and to download the requested software from the trusted entity 160 or other network entity. The trusted entity 160 or other network entity can also be configured to push an image file or image files to the computing device 120 in response to a request from the computing device 120. The software update unit can install the updates included in an image file, update the configuration files using the information included in the image file, and/or perform one or more certificate actions identified in the image file responsive to the image file having been signed by a valid certificate that is found in the memory 290 of the computing device. The certificate must be active and not have been revoked in order for the certificate to be a valid signing certificate for the image file.

The software update unit 362 can be configured to operate in conjunction with the certificate management unit 364 to confirm that an image file has been signed by a valid certificate. The software update unit can be configured to request that the certificate management unit 364 verify whether an image file has been signed by a valid certificate and/or to perform a certificate action on a certificate, such as a activation action to activate a certificate or a revocation action to revoke a certificate stored in the memory 290 of the computing device 120. The software update unit 362 can be configured to install an update included in an image file and/or to update configuration files based on information included in the image file responsive to the certificate management unit 364 indicating that the image file has been signed by a valid certificate. If the image file has not been signed by a valid certificate, the image file could potentially contain malicious software or configuration information that could be used to assume control of the computing device 120, to capture sensitive information from the memory 260 and/or the memory 290 of the computing device 120, and/or to cause other undesirable behavior of the computing device 120.

The certificate management unit 364 can be configured to determine an image file has been signed by a valid certificate that is stored in the memory 290 of the computing device 120. The certificate management unit 364 can also be configured to perform a certificate action on a certificate, such as an activation action to activate a certificate or a revocation action to revoke a certificate stored in the memory 290 of the computing device 120. The certificate management unit 364 can be configured to revoke a certificate by locating the hash of the certificate stored in the memory 290 of the computing device 120, looking up the hash of the certificate in the hash table in the memory 290, and by blowing a fuse or otherwise permanently setting the value of an indicator associated with the certificate that indicates whether the certificate has been revoked. The certificate management unit 364 can be configured to revoke a certificate by locating the hash of the certificate stored in the memory 290 of the computing device 120 and by blowing a fuse or otherwise permanently setting the value of an indicator associated with the certificate that indicates whether the certificate has been revoked.

The certificate management unit 364 can perform a revocation action on a certificate that is active or has not been activated. The certificate management unit 364 can be configured to determine whether any other root certificates are marked as being active in the memory 290 of the mobile device prior to revoking a certificate that is currently active to avoid placing the computing device 120 into a state where there are no active root certificates stored in the memory 290. The software update unit 362 can be configured to request that the certificate management unit 364 verify the signing certificate with the trusted entity 160 prior to proceeding with the provisioning process or with a revocation or activation action. The software update unit 362 can be configured to reject unsigned image files or to prevent unsigned image files from making updates to the activation and revocation fuses associated with certificates in the memory 290.

The certificate management unit 364 can be configured to revoke any certificates that are signed by a certificate that is being revoked. The certificate management unit 364 can be configure to examine the other certificates stored in the memory 290 when revoking a certificate to identify those certificates that have been signed by the certificate being revoked and can then revoke those certificates depending from the revoked certificate. If an attempt is made later to activate any of the revoked certificates at a later time, the certificate management unit 364 will read the fuses associated with the certificate and determine that the certificate has already been revoked and will prevent activation of the certificates.

The data access unit 366 can be configured to store data in the memory 260, the memory 290, and/or other data storage devices associated with the computing device 120. The data access unit 366 can also be configured to access data in the memory 260 and/or other data storage devices associated with the computing device 120. The data access unit 366 can be configured to receive requests from other functional units and/or components of the computing device 120 and to store and/or access data stored in the memory 260, memory 290, and/or other data storage devices associated with the computing device 120.

FIG. 4 is a block diagram illustrating aspects of managing certificates in a memory of a computing device according to the techniques discussed herein. The computing device 120 can be associated with one or more certificates. The certificates can include root certificates and attestation certificates. The size of the one-time programmable memory 290 is limited and the techniques disclosed herein avoid storing the entire certificate in order to reduce the amount of memory required to store the chain of certificates. Rather than storing the certificates in the memory 290 of the computing device 120, a hash of each of the certificates is stored in the memory to reduce the amount of memory required to store the certificate information for the computing device 120. A provisioning process is performed at some point before the computing device 120 is provided to the end user. This provisioning process can be performed by the manufacturer, a reseller, a wireless communication network provider, other entity prior to the computing device 120 being provided to the end user.

In the example illustrated in FIG. 4, a set of n certificates are provisioned on the computing device 120, wherein n is an integer greater than or equal to 3. In other implementations, less than three certificates may be provisioned on the computing device 120. A hash function 410 is applied to each of the certificates (405-0, 405-1, . . . and 405-n) to generate a hash value (hash of the certificate 415) for each of the certificates resulting in n hash values. The hash value of each of the n certificates can be stored in the one-time programmable memory 290 of the computing device 120. The hash value of each of the certificates can occupy significantly less space than the corresponding certificate would occupy in the memory 290, which can result in the computing device 120 requiring less memory 290 to store the certificate information. The resulting reduction in memory requirements can free up the expensive one-time programmable memory 290 for storing other data or can result in a reduction of the overall amount of one-time programmable memory 290 required by the computing device 120, which can help to reduce the manufacturing costs of the computing device 120.

The provisioning techniques can also include generating a certificate hash table 440 that is to be stored in the memory 290. The hash table 440 provides a mapping between the hash of the certificate 415 stored in the memory 290 and a set of fuses in the memory that serve as activation and/or revocation indicators associated with the certificate. The hash table can be constructed by applying a hash function 420 to the hash of the certificates 415 to determine a hash of the hash 425 for each of the certificates. The hash function 420 can be the same hash function as the hash function 410 or can be a different hash function. The hash function 420 can be selected such that each hash of the hash value 425 is a different value. The number of certificates to be stored and the hash values of each of the certificates to be stored is known in advance, which allows for the selection of a hash function generate the hash of the hash value 425 for each certificate such that collisions can be avoided. Each hash of the certificate 415 stored in the memory can be associated with a first fuse or other indicator 430 that indicates whether the certificate has been revoked and a second fuse or other indicator 435 that indicates whether the certificate has been activated. While the fuses have been referred to as “first” and “second” fuses for the sake of clarity, the order of the fuses does not need to be in the order specified in the example. Furthermore, as discussed above, the memory 290 can be implemented using a different type of one-time programmable memory that does not utilize fuses and the fuses referred can be used to represent an indicator for storing a value that is appropriate for the type of memory that has been used to implement memory 290.

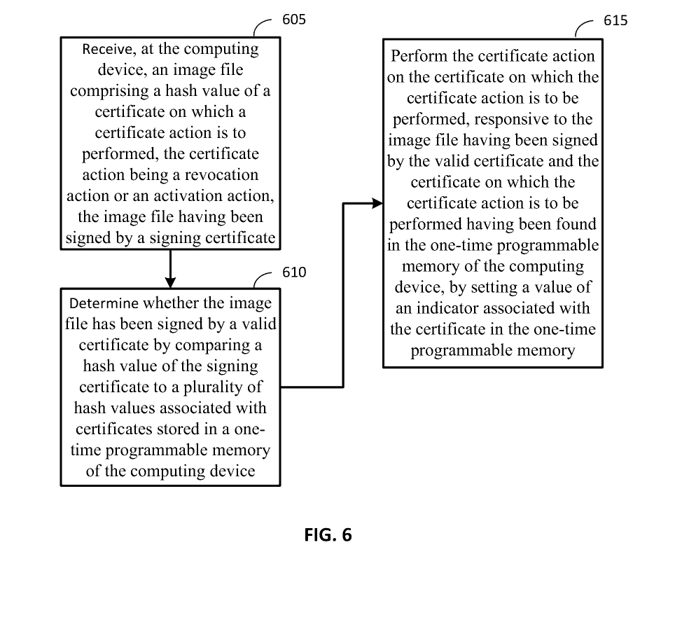

The computing device 120 can be configured to receive an image file that identifies a certificate action to be performed one or more of the certificates stored in the memory 290. The image file can include certificate action information regarding revocation and/or activation actions to be performed. The certificate action information can include hash of the certificate on which the certificate action is to be performed. Storing the hash of the certificate in the image file rather than the entire certificate can decrease the overall size of the image files to be provided to the computing device 120, which can reduce the overall network resources required to provide the image files to the computing devices resulting in less bandwidth usage and a reduction in data related costs for computing devices which are subject to caps on the amount of data that the device can transfer across the network over a given period of time. Examples processes illustrating revocation and activation actions are illustrated in FIGS. 6-12, which will be discussed in detail below.

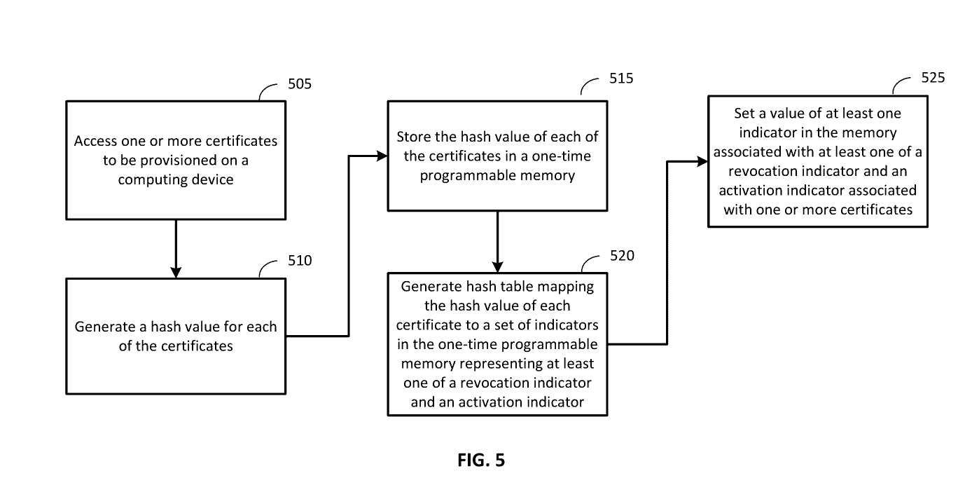

The order of the stages of the processes illustrated in FIGS. 5-14 are provided as examples of the techniques disclosed herein and are not intended to limit the scope of the disclosure to performing the stages of these processes in the specific order illustrated. The order of the stages of these processes can be changed without departing from the scope of the disclosure. Furthermore, additional stages may be added and/or one or more stages may be removed from one or more of the processes discussed herein.

FIG. 5 is a flow diagram of an example process for provisioning according to the techniques discussed herein. The technique illustrated in FIG. 5 can be used to provision a computing device 120 with certificates to be stored in the memory 290. The technique illustrated in FIG. 5 can be performed by a manufacturer or seller of the computing device 120 to provision the certificates to be used by the computing device 120. The technique illustrated in FIG. 5 can be performed by connecting the computing device 120 to a provisioning server via a wired or wireless connection that allows the provisioning server to write data to the one-time programmable memory 290 of the computing device 120. The provisioning server can be implemented by the trusted entity 160 or may comprise one or more other network entities. The provisioning server can be configured perform the stages of the technique illustrated in FIG. 5. The provisioning server can be implemented using computer hardware similar to that illustrated in FIG. 2. However, the provisioning server may include additional software and hardware components not included on the computing device 120. The process illustrated in FIG. 5 can be used to generate the hashes of the certificates 415 and the hash table 440 in the memory 290 of the computing device 120 as well as set of one or more of a first fuse or other indicator 430 and a second fuse or other indicator 435 as illustrated in FIG. 4.

Certificate information for one or more certificates to be provisioned to a computing device can be accessed (stage 505). The certificate can include one or more root certificates, attestation certifications, and/or other types of certificates to be provisioned to the computing device 120. A root certificate can be associated one or more attestation certificates and one or more versions of each attestation certificate. The provisioning server can access a database that includes the certificates to be provisioned to the computing device.

A hash of each of the certificates can be generated (stage 510). The provisioning server can be configured generate a hash of each of the certificates to be provisioned to the computing device. The hash of each of the certificates can be stored in the one-time programmable memory 290 of the computing device 120 (stage 515). The provisioning server can store the hash of the certificates in the one-time programmable memory 290 of the computing device 120 rather than the certificates in order to provide a more compact chain of certificates in the memory 290 of the computing device 120. The smaller footprint of the chain of certificates consumes less space in the one-time programmable memory 290, which can be used to store other data or can allow the computing device 120 to include less of such memory that would otherwise be required to store the certificate information and other data required by the computing device 120.

A hash table mapping the hash value of each of the certificates to a set of indicators in the one-time programmable memory can be generated (stage 520). A hash table similar to hash table 440 illustrated in FIG. 4 can be created in the memory 290 of the computing device 120 by the provisioning server. The set of fuses or other indicators can represent at least one of a first fuse or other indicator 430 that serves as a revocation indicator and a second fuse or other indicator 435 that serves as an activation indicator associated with the certificate represented by the hash of the hash value 425.

A value of at least one indicator in the memory associated with at least one of a revocation indicator and an activation indicator associated with one or more certificates can be set (stage 525). As discussed above, each indicator can be represented by one or more fuses in the memory 290 of the computing device 120, and a value of the indicator can be irrevocably set by blowing one or more of the fuses associated with the indicator. The provisioning server can be configured to activate one or more certificates by blowing the activation indicator fuse associated with the certificate. In some implementations, the memory 290 may not comprise fuses and the one or more indicators can be set using a technique appropriate for the type of memory comprising the memory 290.

The provisioning server can activate more than one root certificate at a time in some implementations. In other implementations, the provisioning server can be configured to only activate a single root certificate on the computing device 120 in other implementations. For example, the computing device 120 can be configured such that only one root certificate can be active at a time, and the certificate management unit 364 can be configured to implement a Root of Trust (ROT) transfer feature in which the certificate management unit 364 will only activate a different root certificate if the currently active root certificate can be revoked. The provisioning server can also be configured to activate one or more attribution certificates on the computing device 120. The provisioning server can be configured to activate one or more versions of an attribution certificate where multiple version of the attribution certificate are present in the certificates that have been provisioned to the memory 290 of the computing device 120. The provisioning server can be configured to revoke one or more of the certificates that have been provisioned to the memory 290 of the computing device 120. The provisioning server can be configured to provide a user interface that enables an administrator of the certificates to be provisioned to the computing device 120 and/or other computing devices to configure which certificates are to be provisioned as well as the activation and/or revocation settings for each certificate.

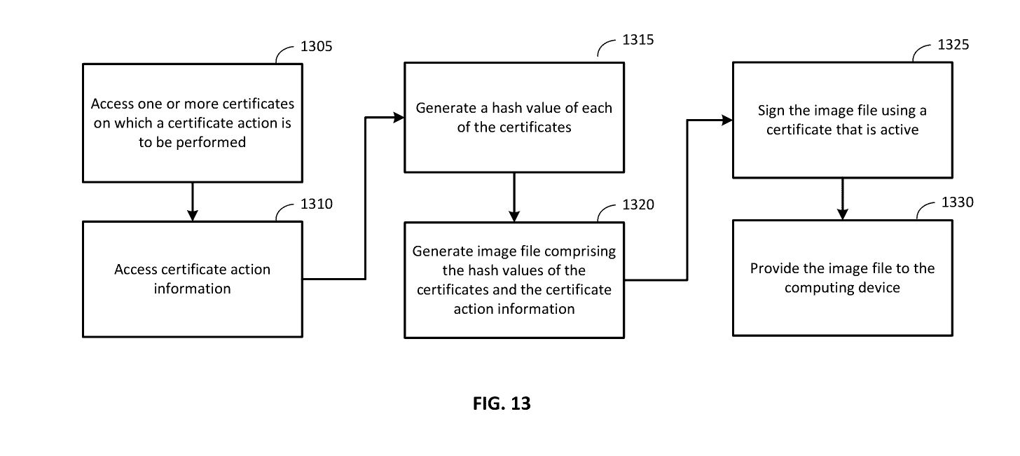

FIG. 13 is a flow diagram of an example process for generating an image file that can be used to provision certificates on a computing device or to manage the certificates already on the device according to the techniques discussed herein. The technique illustrated in FIG. 13 can be used to provision a computing device 120 with certificates to be stored in the memory 290 using a provisioning server. The technique illustrated in FIG. 13 can be performed by a manufacturer or seller of the computing device 120 to provision the certificates to be used by the computing device 120. The technique illustrated in FIG. 13 can be performed by generating an image file which can be used to provision the certificates on the computing device 120. The provisioning server can be implemented by the trusted entity 160 or may comprise one or more other network entities. The provisioning server can be implemented using computer hardware similar to that illustrated in FIG. 2. However, the provisioning server may include additional software and hardware components not included on the computing device 120.

One or more certificates on which a certificate action is to be performed can be accessed (stage 1305). The certificate action can be a provisioning action in which certificates are provisioned to a computing device 120 or may be an activation action or a revocation action associated with certificates already provisioned on the computing device 120.

Certificate action information can be accessed for the certificates (stage 1310). The certificate can include one or more root certificates, attestation certifications, and/or other types of certificates to be provisioned to the computing device 120. A root certificate can be associated one or more attestation certificates and one or more versions of each attestation certificate. The provisioning server can access a database that includes the certificates to be provisioned to the computing device.

A hash value can be generated for each of the certificates (stage 1315). The provisioning server can be configured generate a hash of each of the certificates to be provisioned to the computing device. The provisioning server can be configured to include an identifier for the hash function used to generate the hash of the certificates in the image file, so that the computing device can utilize the same hash function when working with the certificates provisioned to the computing device 120.

An image file comprising the hash values of the certificates and the certificate action information can be generated (stage 1320). The hash values of the certificates and any certificate actions associated with the certificates can be included in the image file to be provided to the computing device 120. Including the hash of the certificates rather than the certificates themselves can significantly reduce the size of the image file, which can reduce the network bandwidth and the costs associated with utilizing this bandwidth for sending the image file to the computing device 120.

The image file can be signed by a signing certificate that is active (stage 1325). For revocation actions and/or activation actions, the signing certificate can be a certificate that has been activated on the computing device 120 and has not been revoked. The signing certificate can be the subject of a certificate action. For example, the signing certificate can be revoked in a certificate action included in the image file so long as the certificate has been activated and remained unrevoked on the computing device 120 at the time that the image file is received at the computing device 120. For provisioning actions, the certificates have not yet been activated on the computing device 120, the signing certificate can be a certificate that the certificate management unit 364 of the computing device 120 can verify with the trusted entity 160 or another network entity to ensure that the signing certificate is active and valid.

The signed image file can then be provided to the computing device 120 (stage 1330). The provisioning server can then send the signed image file to the computing device 120 via the network 110 and/or other networks. The provisioning server can make the signed image file available for download from the provisioning server or from another network entity.

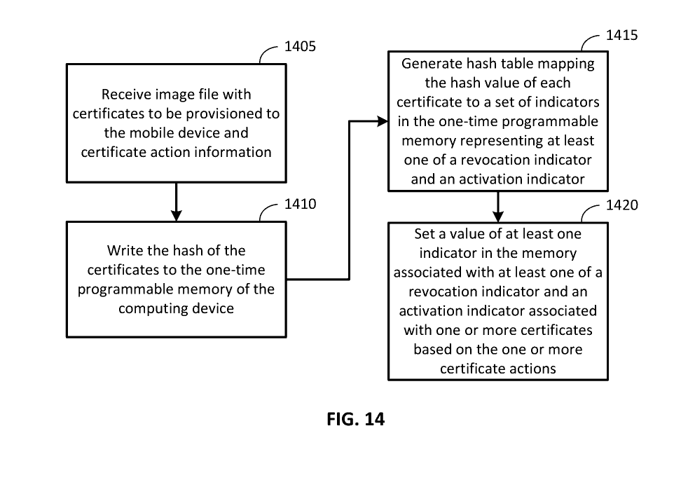

FIG. 14 is a flow diagram of an example process for provisioning according to the techniques discussed herein. The process illustrated in FIG. 14 can be implemented in a computing device, such as the computing device 120 illustrated in FIGS. 1-3, and unless otherwise specified, the software update unit 362 and the certificate management unit 364 of the computing device provide means for implementing the stages of the process of FIG. 14. The process illustrated in FIG. 14 can be used to provision a computing device 120 using an image file generated by the provisioning server, such as by the process illustrated in FIG. 13.

An image file that includes certificates to be provisioned to the mobile device and certificate action information can be received at the computing device 120 (stage 1405). The image file can include a provisioning indicator that indicates that the image file is for provisioning certificates on the computing device 120. The software update unit 362 can be configured to read an indicator in the memory 290 and to halt the process if certificates have already been provisioned to the computing device 120. The software update unit 362 can be configured to set this indicator upon completion of the provisioning process illustrated in FIG. 14 or the provisioning server can set this indicator after completing the process illustrated in FIG. 5. The provisioning server can send an image file to the computing device 120 via the network 110 and/or another network connection. The computing device 120 can also be configured to download the image file generated by the provisioning server from the provisioning server and/or another network entity, such as the trusted entity 160. The image file can include one or more certificates to be provisioned to the computing device 120 and one or more certificate action indicators included in the image file that identify an action or actions to be performed on one or more of the certificates included in the image file. The software update unit 362 can be configured to determine whether the image file has been signed by a valid certificate before provisioning the certificates included in the image file to the computing device 120. The software update unit 362 can be configured to request that the certificate management unit 364 verify the signing certificate with the trusted entity 160 prior to proceeding with the provisioning process. The software update unit 362 can be configured to reject unsigned image files or to prevent unsigned image files from making updates to the activation and revocation bits associated with certificates in the memory 290.

The hash of the certificates to be provisioned can be written to the one-time programmable memory of the computing device (stage 1410). The certificates included in the image file may have already been hashed by the provisioning server and the hash of the certificates may have been included in the image file. The certificate management unit 364 can be configured to copy the hashes of the certificates included in the hash file to the memory 290 responsive to the hashes having been provided in the image file. The certificate management unit 364 can be configured to generate the hash of each of the certificates included in the image file if the provisioning server provided an image file that included the certificates rather than a hash of each of the certificates. The certificate management unit 364 can then write the hash of the certificates to the memory 290.

A hash table mapping the hash value of each of the certificates to a set of indicators in the one-time programmable memory can be generated (stage 1415). A hash table similar to hash table 440 illustrated in FIG. 4 can be created in the memory 290 of the computing device 120 by the certificate management unit 364. The set of fuses or other indicators can include at least one of first fuse or other indicator 430 that serves as a revocation indicator and a second fuse or other indicator 435 that serves as an activation indicator associated with the certificate represented by the hash of the hash value 425. As discussed above, the first fuse or other indicator 430 and the second fuse or other indicator 435 can each be implemented as one or more fuses where the memory 290 is a type of one-time programmable memory that includes fuses. The first fuse or other indicator 430 and the second fuse or other indicator 435 can each be implemented by an antifuse or other type of indicator in the memory 290 that can be used to irrevocably set the values associated with the first fuse or other indicator 430 and the second fuse or other indicator 435 as is appropriate for the type of one-time programmable memory that is being used.

A value of at least one indicator in the memory associated with at least one of a revocation indicator and an activation indicator for each of one or more certificates can be set based on the one or more certificate actions (stage 1420). As discussed above, each indicator can be represented by one or more fuses or other indicators in the memory 290 of the computing device 120, and a value of the indicator can be irrevocably set by blowing one or more of the fuses or otherwise irrevocably setting a value in the one-time programmable memory associated with the indicator. Other types of actions can be used to set the revocation indicator and/or the activation indicator where other types of one-time programmable memory have been used to implement memory 290. In some implementations, the memory 290 may not comprise fuses and the one or more indicators can be set using a technique appropriate for the type of memory comprising the memory 290.

The certificate management unit 364 can be configured to activate and/or revoke one or more certificates by setting the value of the second fuse or other indicator 435 serving as an activation indicator and/or the first fuse serving as a revocation indicator associated with the certificate. The certificate management unit 364 can be configured to activate and/or revoke the certificates based on certificate action indicators included in the image file. The certificate action indicator can also include an indicator identifying the hashing algorithm that was used to generate the hash of the certificate associated with the certificate action indicator included in the image file so that the certificate management unit 364 can utilize the correct hashing algorithm when generating the hash of the certificates 415 and the hash table 440.

FIG. 6 is a flow diagram of an example process for managing certificates on a computing device according to the techniques discussed herein. The process illustrated in FIG. 6 can be implemented in a computing device, such as the computing device 120 illustrated in FIGS. 1-3, and unless otherwise specified, the software update unit 362 and the certificate management unit 364 of the computing device provide means for implementing the stages of the process of FIG. 6.

An image file can be received at the mobile device that includes a hash of a certificate on which a certificate action is to be performed (stage 605). The certificate action can be a revocation action or an activation action, and the image file can have been signed by a signing certificate. The image file can comprise software updates, configuration files updates, and/or certificate action information regarding revocations and/or activation information. The software update unit 362 of the computing device can be configured to receive the image file at the computing device 120 via a wired or wireless network connection. As discussed above, the image file can be provided by the trusted entity 160 or other network entity. In some implementations, the image file can also be accessed from another computing device that is connected to the computing device 120 via a wired or wireless connection.

The signing certificate is a root certificate or an attestation certificate that has been used to sign the image file to indicate that the image file comes from a trusted source. The validity of the signing certificate can be checked by the software update unit 362 prior to performing any updates to software or configuration files of the computing device 120. The software update unit 362 can also check the validity of the signing certificate before performing any certificate actions on one or more certificates in the memory 290 of the computing device 120.

Certificates stored in the memory 290 of the computing device 120 can be managed by including a certificate action indicator in a signed image file. The indicator can identify a certificate action to be performed on one or more certificates that may be stored in the one-time programmable memory 290 of the computing device 120. The certificate action can be associated with a copy of the certificate on which the certificate action is to be performed. Alternatively, the certificate action can be associated with a hash of the certificate on which the certificate action is to be performed. The hash of the certificate can be included in the image file in order to reduce the size of the image file to be provided to the computing device 120. The certificate action indicator can also include an indicator identifying the hashing algorithm that was used to generate the hash of the certificate associated with the certificate action indicator included in the image file so that the certificate management unit 364 can utilize the correct hashing algorithm when comparing the hash of the certificate to the hashes of the certificates stored in the memory 290.

A determination can be made whether the image file has been signed by a valid certificate by comparing a hash value of the signing certificate to at least one hash value associated with certificates stored in a one-time programmable memory of the computing device (stage 610). As discussed above with respect to FIG. 4, when the computing device 120 is provisioned or initially configured, the hash of the root certificates and/or attestation certificates that may be used by the computing device 120 can be determined and stored in the one-time programmable memory 290 of the computing device 120 in order to reduce the footprint of the chain of certificates stored in the memory 290 of the computing device 120. The

The certificate action can be performed on the certificate responsive to the image file having been signed by a valid certificate and the certificate on which the certificate action is to be performed having been found in the one-time programmable memory of the computing device by setting an indicator associated with the certificate in the one-time programmable memory (stage 615). The indicator can be set by blowing at least one fuse associated with the certificate in the one-time programmable memory or by setting the another type of indicator in the memory 290 that can be used to irrevocably store the value in the memory 290 appropriate for the type of one-time programmable memory that is being used. The certificate management unit 364 can be configured to perform the certificate action indicated in the image file responsive to the image file having been signed by a valid certificate and the certificate on which the action is to be performed being found by the certificate management unit 364 in the memory 290 of the mobile device. The certificate management unit 364 can be configured to activate a particular root certificate or attestation certificate only if that certificate has not been previously revoked. A certificate can be irrevocably revoked by blowing the fuse or by setting the other indicator in the memory 290 associated with the certificate that indicates that the certificate has been revoked. The certificate management unit 364 can be configured to determine whether there are any other root certificates active prior to revoking a root certificate. The certificate management unit 364 can be configured to only revoke a root certificate if there is at least one other root certificate active and not revoked stored in the memory 290 of the computing device 120.

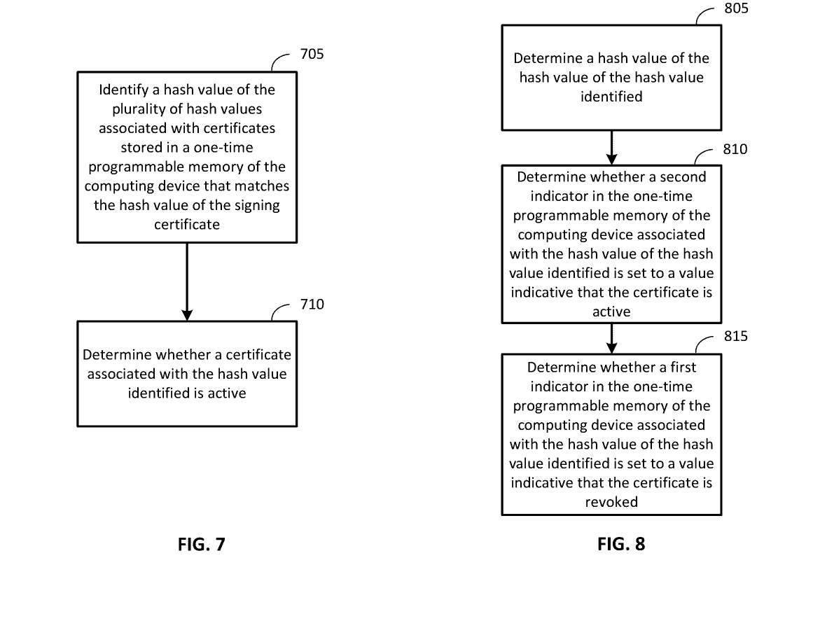

FIG. 7 is a flow diagram of an example process for determining whether a certificate is active on a computing device according to the techniques discussed herein. The process illustrated in FIG. 7 can be implemented in a computing device, such as the computing device 120 illustrated in FIGS. 1-3, and unless otherwise specified, the software update unit 362 and the certificate management unit 364 of the computing device provide means for implementing the stages of the process of FIG. 7. The process illustrated in FIG. 7 can be used to implement stage 610 of the process illustrated in FIG. 6.

The process illustrated in FIG. 7 can be used by the certificate management unit 364 to determine whether a signing certificate used to sign an image file is an active certificate according to the certificate information stored in the memory 290 of the computing device 120. If the certificate used to sign the image file is not active or has been revoked, the certificate management unit 364 can be configured to not perform any certificate action indicators included in the file, which could be used to revoke or activate certificates in the memory 290. Furthermore, the certificate management unit 364 can be configured to notify the software update unit 362 whether the signing certificate was an active certificate or was revoked. The software update unit 362 can be configured to not install software updates and/or make updates to configuration files based on the contents of the image file responsive to the signing certificate having either been revoked or not active.

A hash value of the plurality of hash values associated with certificates stored in a one-time programmable memory of the computing device can be identified that matches the hash value of the signing certificate (stage 705). As discussed above with respect to FIG. 4, a hash of each of the root certificates and or attestation certificates can be stored in the memory 290 rather than the certificates themselves in order to significantly reduce the footprint of the chain of certificates. The hash value of the signing certificate can be determined by the certificate management unit 364 responsive to the image file including the signing certificate itself rather than a hash of the signing certificate. The hash of the signing certificate can be compared to the hash of each of the certificates stored in the memory 290 to determine whether the certificate is one of the certificates included in the memory 290. If the hash of the signing certificate does not match the hash of any of the certificates in the memory 290, the certificate management unit 364 can be configured to make a determination that the signing certificate is not one of the active certificates stored on the computing device 120 and the process can terminate without proceeding to stage 710. However, if the certificate management unit 364 determines that the hash value of the signing certificate matches the hash value of one of the certificates stored in the memory 290 of the computing device 120, the process can proceed to stage 710 where a determination whether the certificate associated with the matching hash value is active indicating that the signing certificate is an active certificate in the memory 290 of the computing device 120.

A determination whether a certificate associated with the hash value identified is active can be made (stage 710). As discussed above with respect to FIG. 4, a hash table can be stored in the memory 290 of the computing device 120. The certificate management unit 364 can be configured to check the values of fuses or other indicators in the one-time programmable memory 290 to determine whether the certificate associated with the hash value identified is active and has not been revoked indicates that the signing certificate, which has the same hash value, is an active and unrevoked certificate. If these conditions are met, then the signing certificate is valid and the certificate management unit 364 can proceed with the certificate action included in the image file or perform another action specified in the image file. An example process for determining whether the signing certificate is an active certificate in the memory is illustrated in FIG. 8, which is discussed below.

FIG. 8 is a flow diagram of an example process for determining whether a certificate is active on a computing device 120 according to the techniques discussed herein. The process illustrated in FIG. 8 can be implemented in a computing device, such as the computing device 120 illustrated in FIGS. 1-3, and unless otherwise specified, the software update unit 362 and the certificate management unit 364 of the computing device provide means for implementing the stages of the process of FIG. 7. The process illustrated in FIG. 8 can be used to implement stage 710 of the process illustrated in FIG. 7. The process illustrated in FIG. 8 can be used by the certificate management unit 364 to determine whether a particular certificate has been marked as active and has not been revoked by checking the fuses in the one-time programmable memory 290 associated with the certificate.

A hash value of the hash value identified can be determined (stage 805). The hash value of the of the hash value of the certificate identified in stage 705 can be determined by the certificate management unit 364. The hash value of the hash value can be used to look up the fuses associated with the certificate in the memory 290.

A determination can be made whether a second fuse or second indicator in the one-time programmable memory of the computing device associated with the hash value of the hash value identified is set to a value indicative that the certificate is activated (stage 810). As discussed above with respect to FIG. 4, a hash table can be stored in the memory 290 of the computing device 120. The hash table can map the hash of each of the certificates to a set of fuses in the memory 290. A hash of a certificate can be looked up in the hash table to retrieve information identifying the location of a set of fuses in the memory 290 that can be used to indicate whether the certificate has been activated and/or revoked. The set of fuses or other indicators can include a second fuse or second indicator that indicates whether the certificate is active, and a first fuse or first indicator that indicates whether the certificate has been revoked. The certificate management unit 364 can read the values of these fuses or other indicators to determine whether the signing certificate has not been revoked and is activated. If these conditions are met, then the signing certificate is valid and the certificate management unit 364 can proceed with the certificate action included in the image file or perform another action specified in the image file. The certificate management unit 364 can determine whether the first fuse or first indicator associated that indicates whether the certificate is active. If the first fuse has not been blown or the first indicator has not been set, the certificate has not been activated, and the process can halt with the certificate management unit 364 determining that the certificate is not active. If the certificate is marked as active, the process can continue with stage 815.

Determine whether a first fuse or first indicator in the one-time programmable memory of the computing device associated with the hash value of the hash value identified is set to a value indicative that the certificate is revoked (stage 815). The certificate management unit 364 can determine whether a first fuse or first indicator associated with the certificate has been blown, indicating that the certificate has been irrevocably revoked. The certificate management unit 364 can be configured to determine that the certificate is active and has not been revoked responsive to the second fuse or other indicator having been set and the first fuse or other indicator having not been set. The certificate management unit 364 can be configured to determine that the certificate is not active and has been revoked if the first fuse or other indicator has been set regardless of whether the second fuse or second indicator has been set. A previously active certificate can be revoked by blowing the first fuse or setting first indicator associated with the certificate depending on the type of memory used to implement memory 290.

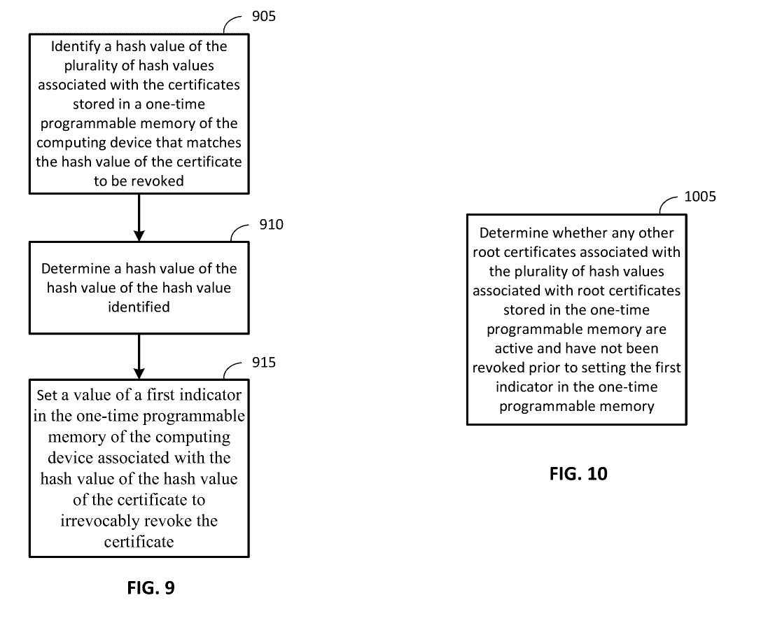

FIG. 9 is a flow diagram of an example process for revoking a certificate on a computing device according to the techniques discussed herein. The process illustrated in FIG. 9 can be implemented in a computing device, such as the computing device 120 illustrated in FIGS. 1-3, and unless otherwise specified, the software update unit 362 and the certificate management unit 364 of the computing device provide means for implementing the stages of the process of FIG. 9. The process illustrated in FIG. 9 can be used to implement stage 615 of the process illustrated in FIG. 6 where the certificate action is a revocation action.

A hash value of the plurality of hash values associated with certificates stored in a one-time programmable memory 290 of the computing device can be identified that matches the hash value of the certificate on which the revocation action to be performed (stage 905). The software update unit 362 can receive an image file that contains certificate action information regarding the revocation of a certificate that may be stored in the memory 290. The certificate action information can include a hash value of the certificate to be revoked. The certificate action information can also include either a reference to the entire certificate or the entire certificate to be revoked, and the certificate management unit 364 can be configured to apply a hash function to the certificate to the certificate to generate a hash value of the certificate. As discussed above with respect to FIG. 4, the hash value of a plurality of certificates of which the computing device 120 may make use can be stored in the memory 290 of the computing device 120. The certificates stored for which the hash values are stored in the memory 290 can include root certificates, attestation certificates, or a combination thereof. The certificate management unit 364 can be configured to compare the hash value of the certificate to be revoked according to the certificate action information with the hash of each of the certificates in the memory 290 to identify a hash value of a certificate in memory that matches the hash value of the certificate to be revoked. If no match is found between the hash of the certificate to be revoked and the hash of the certificates in the memory 290, the process can end with stage 905 because the certificate that was to be revoked was not found in the memory 290.

A hash value of the hash value identified can be determined (stage 910). The hash value of the hash value of the certificated identified in stage 905 can be used to retrieve information identifying the location of a set of fuses in the memory 290 that can be used to indicate whether the certificate has been activated and/or revoked. Referring back to FIG. 4, a hash table can be stored in the memory 290 of the computing device 120. The hash table can map the hash of each of the certificates to a set of fuses in the memory 290. A hash of a certificate can be looked up in the hash table to retrieve information identifying the location of a set of fuses in the memory 290 that can be used to indicate whether the certificate has been activated and/or revoked. The set of fuses can include a second fuse that indicates whether the certificate is active and a first fuse that indicates whether the certificate has been revoked. The certificate management unit 364 can read the values of these fuses to determine whether the certificate has not been revoked and is activated. If the first fuse indicating that the certificate is revoked has already been blown, the certificate has already been revoked and the process can end with stage 910. Otherwise, the process can continue with stage 915.

A value of a first fuse or first indicator in the one-time programmable memory of the computing device associated with the hash value of the hash value of the certificate can be set to irrevocably revoke the certificate (stage 915). The certificate management unit 364 can be configured to blow the first fuse or set the value of the first indicator associated with the certificate to be revoked in the memory 290 in order to irrevocably revoke the certificate, since the memory 290 is one-time programmable memory. Once the bit represented by the first fuse or other indicator is set, the certificate is revoked and cannot be activated or unrevoked on the computing device 120.

FIG. 10 is a flow diagram of an example process for revoking a root certificate on a computing device according to the techniques discussed herein. The process illustrated in FIG. 10 can be implemented in a computing device, such as the computing device 120 illustrated in FIGS. 1-3, and unless otherwise specified, the software update unit 362 and the certificate management unit 364 of the computing device provide means for implementing the stages of the process of FIG. 10. The process illustrated in FIG. 10 can be used to implement an optional additional stage of the process illustrated in FIG. 9 in which the certificate action is a revocation action. The process illustrated in FIG. 10 can be performed before or after any of the stages of FIG. 9 prior to stage 915 in which the first fuse associated with the certificate is blown and the certificate to be revoked is a root certificate. The process illustrated in FIG. 10 can be used to ensure that at least one valid other root certificate remains on the computing device 120 of a revocation is issued on a root certificate.

A determination whether any other root certificates associated with the plurality of hash values associated with certificates stored in the one-time programmable memory are active and have not been revoked prior to setting the value of the first fuse or first indicator in the one-time programmable memory can be made (stage 1005). The certificate management unit 364 can be configured to determine whether there is at least one other root certificate active and unrevoked on the computing device 120 before permanently revoking the certificate to be revoked. The certificate management unit 364 can be configured to check the first fuse or first indicator and the second fuse or second indicator associated with each of the certificates in the memory 290 to determine whether any of the other root certificates are active and unrevoked. For example, where the memory 290 is implemented using fuses, the second fuse associated with the other root certificate should be blown to indicate that the certificate is active and the first fuse associated with the other root certificate should not be blown indicating that the other root certificate has not been revoked.

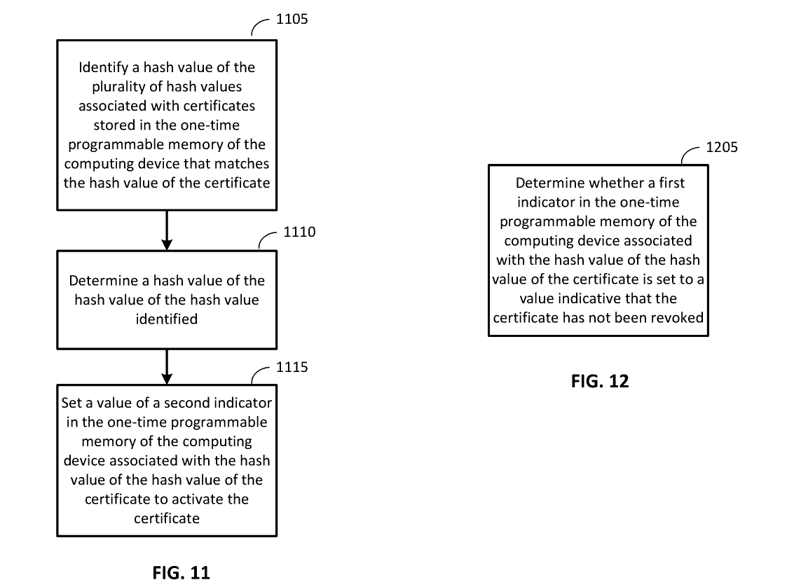

FIG. 11 is a flow diagram of an example process for activating a certificate on a computing device according to the techniques discussed herein. The process illustrated in FIG. 9 can be implemented in a computing device, such as the computing device 120 illustrated in FIGS. 1-3, and unless otherwise specified, the software update unit 362 and the certificate management unit 364 of the computing device provide means for implementing the stages of the process of FIG. 9. The process illustrated in FIG. 7 can be used to implement stage 615 of the process illustrated in FIG. 6 where the certificate action is an activation action.

A hash value of the plurality of hash values associated with certificates stored in a one-time programmable memory 290 of the computing device can be identified that matches the hash value of the certificate on which the activation action to be performed (stage 1105). The software update unit 362 can receive an image file that contains certificate action information regarding the activation of a certificate that may be stored in the memory 290. The certificate action information can include a hash value of the certificate to be activated. The certificate action information can also include either a reference to the entire certificate or the entire certificate to be activated, and the certificate management unit 364 can be configured to apply a hash function to the certificate to the certificate to generate a hash value of the certificate responsive to the hash of the certificate not being provided in the image file. As discussed above with respect to FIG. 4, the hash value of a plurality of certificates of which the computing device 120 may make use can be stored in the memory 290 of the computing device 120. The certificates stored for which the hash values are stored in the memory 290 can include root certificates, attestation certificates, or a combination thereof. The certificate management unit 364 can be configured to compare the hash value of the certificate to be activated according to the certificate action information with the hash of each of the certificates in the memory 290 to identify a hash value of a certificate in memory that matches the hash value of the certificate to be activated. If no match is found between the hash of the certificate to be activated and the hash of the certificates in the memory 290, the process can end with stage 1105 because the certificate that was to be activated was not found in the memory 290.

A hash value of the hash value identified can be determined (stage 1110). The hash value of the hash value of the certificated identified in stage 1105 can be used to retrieve information identifying the location of a set of fuses in the memory 290 that can be used to indicate whether the certificate has been activated and/or revoked. Referring back to FIG. 4, a hash table can be stored in the memory 290 of the computing device 120. The hash table can map the hash of each of the certificates to a set of fuses in the memory 290. A hash of a certificate can be looked up in the hash table to retrieve information identifying the location of a set of fuses in the memory 290 that can be used to indicate whether the certificate has been activated and/or revoked. The set of fuses can include a second fuse that indicates whether the certificate is active and a first fuse that indicates whether the certificate has been revoked. The certificate management unit 364 can read the values of these fuses to determine whether the certificate has not been revoked and is activated. If the second fuse indicating that the certificate has already been activated is blown, the certificate has already been activated and the process can end with stage 1110. Otherwise, the process can continue with stage 1115.

A value of a second indicator in the one-time programmable memory of the computing device associated with the hash value of the hash value of the certificate can be set to activate the certificate (stage 1115). Where the memory 290 is implemented using fuses, the certificate management unit 364 can be configured to blow the first fuse associated with the certificate to be activated in the memory 290 in order to activate the certificate. Once the bit represented by the second fuse is set, the certificate is activated but the certificate can still be revoked by blowing the first fuse associated with the certificate in the memory 290. The certificate management unit 362 can be configured to set the second indicator using a technique appropriate to the type of one-time programmable memory used to implement the memory 290 where the memory does not use fuses.

FIG. 12 is a flow diagram of an example process for activating a certificate on a computing device according to the techniques discussed herein. The process illustrated in FIG. 12 can be used to implement an optional additional stage of the process illustrated in FIG. 11 in which the certificate action is an activation action. The process illustrated in FIG. 12 can be performed before or after any of the stages of FIG. 12 prior to stage 1115 in which the second fuse associated with the certificate is blown. The process illustrated in FIG. 12 can be used to prevent a certificate that has already been revoked from being marked as activated in the memory 290.

A determining whether a first indicator in the one-time programmable memory of the computing device associated with the hash value of the hash value of the certificate is set to a value indicative that the certificate has not been revoked can be made (stage 1205). Where the memory 290 comprises fuses, if the first fuse has been blown, the certificate has been irrevocably revoked and cannot be activated. The certificate management unit 364 can be configured to halt the activation of the certificate responsive to the certificate having already been revoked. Where the process of FIG. 12 is being performed as part of or in conjunction with the process of FIG. 11, the certificate management unit 364 can be configured to halt the process illustrated in FIG. 11 responsive to determining that the certificate to be activated has been revoked. The certificate management unit 362 can be configured determine whether the first indicator has been set using a technique appropriate to the type of one-time programmable memory used to implement the memory 290 where the memory does not use fuses.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media. Tangible media include one or more physical articles of machine readable media, such as random access memory, magnetic storage, optical storage media, and so on.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), and Blu-ray disc where disks usually reproduce data magnetically, while discs reproduce data optically with lasers. Combinations of the above should also be included within the scope of computer-readable media. Such media also provide examples of non-transitory media, which can be machine readable, and wherein computers are an example of a machine that can read from such non-transitory media.

The generic principles discussed herein may be applied to other implementations without departing from the spirit or scope of the disclosure or claims.

What is claimed is:

1. A method for managing certificates on a computing device, the method comprising:
receiving, at the computing device, an image file comprising a hash value of a certificate on which a certificate action is to be performed, the certificate action being a revocation action or an activation action, the image file having been signed by a signing certificate;
determining whether the image file has been signed by a valid certificate by comparing a hash value of the signing certificate to a plurality of hash values associated with certificates stored in a one-time programmable memory of the computing device; and
performing the certificate action on the certificate on which the certificate action is to be performed, responsive to the image file having been signed by the valid certificate and the certificate on which the certificate action is to be performed having been found in the one-time programmable memory of the computing device, by setting a value of an indicator associated with the certificate in the one-time programmable memory.

2. The method of claim 1, wherein the signing certificate and the certificate are a same certificate.

3. The method of claim 1, wherein determining whether the image file has been signed by the valid certificate by comparing the hash value of the signing certificate to the plurality of hash values associated with certificates stored in the one-time programmable memory of the computing device further comprises:
identifying a hash value of the plurality of hash values associated with certificates stored in the one-time programmable memory of the computing device that matches the hash value of the signing certificate; and
determining whether a certificate associated with the hash value identified is active.

4. The method of claim 3, wherein determining whether the certificate associated with the hash value identified is active further comprises:
determining a hash value of the hash value identified; and
determining whether a second indicator in the one-time programmable memory of the computing device associated with the hash value of the hash value identified is set to a value indicative that the certificate is active.

5. The method of claim 4, further comprising:
determining whether a first indicator in the one-time programmable memory of the computing device associated with the hash value of the hash value identified is set to a value indicative that the certificate has not been revoked.

6. The method of claim 1, wherein the certificate action is the revocation action, and wherein performing the certificate action on the certificate further comprises:
identifying a hash value of the plurality of hash values associated with certificates stored in the one-time programmable memory of the computing device that matches the hash value of the certificate;
determining a hash value of the hash value identified; and
setting a value of a first indicator in the one-time programmable memory of the computing device associated with the hash value of the hash value of the hash value identified to irrevocably revoke the certificate.

7. The method of claim 6, further comprising determining whether any other root certificates associated with the plurality of hash values associated with certificates stored in the one-time programmable memory are active and have not been revoked prior to setting the value of the first indicator in the one-time programmable memory.

8. The method of claim 1, wherein the certificate action is the activation action, and wherein performing the certificate action on the certificate further comprises:
identifying a hash value of the plurality of hash values associated with certificates stored in the one-time programmable memory of the computing device that matches the hash value of the certificate;
determining a hash value of the hash value of the certificate; and
setting a value of a second indicator in the one-time programmable memory of the computing device associated with the hash value of the hash value of the certificate to activate the certificate.

9. The method of claim 8, further comprising determining whether the certificate has been revoked by:
determining whether a first indicator in the one-time programmable memory of the computing device associated with the hash value of the hash value of the certificate is set to a value indicative that the certificate has not been revoked.

10. An apparatus comprising:
means for receiving an image file comprising a hash value of a certificate on which a certificate action is to be performed, the certificate action being a revocation action or an activation action, the image file having been signed by a signing certificate;
means for determining whether the image file has been signed by a valid certificate by comparing a hash value of the signing certificate to a plurality of hash values associated with certificates stored in a one-time programmable memory of the apparatus; and
means for performing the certificate action on the certificate responsive to the image file having been signed by the valid certificate and the certificate on which the certificate action is to be performed having been found in the one-time programmable memory of the apparatus by setting a value of an indicator associated with the certificate in the one-time programmable memory.

11. The apparatus of claim 10, wherein the signing certificate and the certificate are a same certificate.

12. The apparatus of claim 10, wherein the means for determining whether the image file has been signed by the valid certificate by comparing the hash value of the signing certificate to the plurality of hash values associated with certificates stored in the one-time programmable memory of the apparatus further comprises:
means for identifying a hash value of the plurality of hash values associated with certificates stored in the one-time programmable memory of the apparatus that matches the hash value of the signing certificate; and
means for determining whether a certificate associated with the hash value identified is active.

13. The apparatus of claim 12, wherein the means for determining whether the certificate associated with the hash value identified is active further comprises:
means for determining a hash value of the hash value identified; and
means for determining whether a second indicator in the one-time programmable memory of the apparatus associated with the hash value of the hash value identified is set to a value indicative that the certificate is active.

14. The apparatus of claim 13, further comprising:
means for determining whether a first indicator in the one-time programmable memory of the apparatus associated with the hash value of the hash value identified is set to a value indicative that the certificate has not been revoked.

15. The apparatus of claim 10, wherein the certificate action is the revocation action, and wherein the means for performing the certificate action on the certificate further comprises:
means for identifying a hash value of the plurality of hash values associated with certificates stored in the one-time programmable memory of the apparatus that matches the hash value of the certificate;
means for determining a hash value of the hash value of the certificate; and
means for setting a value of a first indicator in the one-time programmable memory of the apparatus associated with the hash value of the hash value of the certificate to irrevocably revoke the certificate.

16. The apparatus of claim 15, further comprising means for determining whether any other root certificates associated with the plurality of hash values associated with certificates stored in the one-time programmable memory are active and have not been revoked prior to setting the value of the first indicator in the one-time programmable memory.

17. The apparatus of claim 10, wherein the certificate action is the activation action, and wherein the means for performing the certificate action on the certificate further comprises:
means for identifying a hash value of the plurality of hash values associated with certificates stored in the one-time programmable memory of the apparatus that matches the hash value of the certificate;
means for determining a hash value of the hash value of the certificate; and
means for setting a second indicator in the one-time programmable memory of the apparatus associated with the hash value of the hash value of the certificate to activate the certificate.

18. The apparatus of claim 17, further comprising means for determining whether the certificate has been revoked, the means for determining whether the certificate has been revoked comprising:
means for determining whether a first indicator in the one-time programmable memory of the apparatus associated with the hash value of the hash value of the certificate is set to a value indicative that the certificate has not been revoked.

19. A computing device comprising:
a one-time programmable memory; and
at least one processor coupled to the one-time programmable memory, the at least one processor being configured to:
receive an image file comprising a hash value of a certificate on which a certificate action is to be performed, the certificate action being a revocation action or an activation action, the image file having been signed by a signing certificate;
determine whether the image file has been signed by a valid certificate by comparing a hash value of the signing certificate to a plurality of hash values associated with certificates stored in the one-time programmable memory; and
perform the certificate action on the certificate responsive to the image file having been signed by the valid certificate and the certificate on which the certificate action is to be performed having been found in the one-time programmable memory by setting a value of an indicator associated with the certificate in the one-time programmable memory.

20. The computing device of claim 19, wherein the signing certificate and the certificate are a same certificate.

21. The computing device of claim 19, wherein the certificate action is the revocation action, and wherein the at least one processor being configured to perform the certificate action on the certificate is further configured to:
identify a hash value of the plurality of hash values associated with certificates stored in the one-time programmable memory that matches the hash value of the certificate;
determine a hash value of the hash value of the certificate; and
setting a value of a first indicator in the one-time programmable memory associated with the hash value of the hash value of the certificate to irrevocably revoke the certificate.

22. The computing device of claim 21, wherein the at least one processor is further configured to determine whether any other root certificates associated with the plurality of hash values associated with certificates stored in the one-time programmable memory are active and have not been revoked prior to setting the value of the first indicator in the one-time programmable memory.

23. The computing device of claim 19, wherein the certificate action is the activation action, and wherein the at least one processor being configured to perform the certificate action on the certificate is further configured to:
identify a hash value of the plurality of hash values associated with certificates stored in the one-time programmable memory that matches the hash value of the certificate;
determine a hash value of the hash value of the certificate; and
set a value of a second indicator in the one-time programmable memory associated with the hash value of the hash value of the certificate to activate the certificate.

24. The computing device of claim 23, wherein the at least one processor is further configured to determine whether the certificate has been revoked, the at least one processor being configured to:
determine whether a first indicator in the one-time programmable memory associated with the hash value of the hash value of the certificate is set to a value indicative that the certificate has not been revoked.

25. A non-transitory, computer-readable medium, having stored thereon computer-readable instructions for managing certificates on a computing device, comprising instructions configured to cause the computing device to:
receive an image file comprising a hash value of a certificate on which a certificate action is to be performed, the certificate action being a revocation action or an activation action, the image file having been signed by a signing certificate;
determine whether the image file has been signed by a valid certificate by comparing a hash value of the signing certificate to a plurality of hash values associated with certificates stored in a one-time programmable memory of the computing device; and
perform the certificate action on the certificate responsive to the image file having been signed by the valid certificate and the certificate on which the certificate action is to be performed having been found in the one-time programmable memory of the computing device by setting a value of an indicator associated with the certificate in the one-time programmable memory.

26. The non-transitory, computer-readable medium of claim 25, wherein the signing certificate and the certificate are a same certificate.

27. The non-transitory, computer-readable medium of claim 25, wherein the instructions configured to cause the computing device to determine whether the image file has been signed by the valid certificate by comparing the hash value of the signing certificate to the plurality of hash values associated with certificates stored in the one-time programmable memory of the computing device further comprise instructions configured to cause the computing device to:
identify a hash value of the plurality of hash values associated with certificates stored in the one-time programmable memory of the computing device that matches the hash value of the signing certificate; and
determine whether a certificate associated with the hash value identified is active.

28. The non-transitory, computer-readable medium of claim 25, wherein the certificate action is the revocation action, and wherein the instructions configured to cause the computing device to perform the certificate action on the certificate further comprise instruction configured to cause the computing device to:
identify a hash value of the plurality of hash values associated with certificates stored in the one-time programmable memory of the computing device that matches the hash value of the certificate;
determine a hash value of the hash value of the certificate; and
set a value of a first indicator in the one-time programmable memory of the computing device associated with the hash value of the hash value of the certificate to irrevocably revoke the certificate.

29. The non-transitory, computer-readable medium of claim 25, wherein the certificate action is the activation action, and wherein the instructions configured to cause the computing device to perform the certificate action on the certificate further comprise instructions configured to cause the computing device to:
identify a hash value of the plurality of hash values associated with certificates stored in the one-time programmable memory of the computing device that matches the hash value of the certificate;
determine a hash value of the hash value of the certificate; and
set a value of a second indicator in the one-time programmable memory of the computing device associated with the hash value of the hash value of the certificate to activate the certificate.

30. The non-transitory, computer-readable medium of claim 29, further comprising instructions configured to cause the computing device to determine whether the certificate has been revoked, the computing device being configured to:
determine whether a first indicator in the one-time programmable memory of the computing device associated with the hash value of the hash value of the certificate is set to a value indicative that the certificate has not been revoked.
